(19) United States
(12) Patent Application Publication
(10) Pub. No.: US 2019/0103032 A1
(43) Pub. Date: Apr. 4, 2019

(54) UNMANNED AERIAL VEHICLE, DATA PROCESSING DEVICE, PATH SELECTION DEVICE, PROCESSING METHOD AND PROCESSING PROGRAM

(71) Applicant: TOPCON CORPORATION, Tokyo (JP)

(72) Inventor: You SASAKI, Tokyo (JP)

(73) Assignee: TOPCON CORPORATION, Tokyo (JP)

(21) Appl. No.: 16/147,992

(22) Filed: Oct. 1, 2018

(30) Foreign Application Priority Data
Oct. 3, 2017 (JP) 2017-193683

(51) Int. Cl. G08G 5/02; G08G 5/00; B64C 39/02

(52) U.S. Cl. CPC G08G 5/025; G08G 5/0086; B64C 2201/141; G08G 5/0039; B64C 39/024; G08G 5/0034

(57) ABSTRACT

Disclosed is a path selection device for unmanned aerial vehicle, comprising: a landing position information receiving portion that receives a landing position; a vehicle body position information receiving portion that receives the current position of the unmanned aerial vehicle; a scanned data receiving portion capable of receiving three-dimensional scanned data on a scanned target acquired by scanning by a laser scanner comprised in the unmanned aerial vehicle; a scan map creating portion that creates a three-dimensional map based on the three-dimensional scanned data received by the scanned data receiving portion; a no-fly place extracting portion that extracts a no-fly place forming a flight obstacle in the three-dimensional map; and a path selecting portion that selects, in the three-dimensional map, a flight path of the unmanned aerial vehicle which is from the current position to the landing position and in which the no-fly place can be avoided.

### CROSS-REFERENCE TO RELATED APPLICATION

This application claims priority of Japanese Patent Application No. 2017-193683, filed on Oct. 3, 2017, the entire disclosure of which is incorporated by reference herein.

### TECHNICAL FIELD

The present disclosure relates to a technique allowing an unmanned aerial vehicle to return or land in an optimum path.

### BACKGROUND ART

There is a method of tracking a flying UAV (Unmanned Aerial Vehicle) by a TS (Total Station) and determining the position of the UAV using the laser ranging function of the TS (see, for example, Patent Document 1). Patent Document 1: US 2014/0210663

### SUMMARY

### Problem to be Solved by the Disclosure

During flight of an unmanned aerial vehicle such as a UAV, sometimes the aerial vehicle must be returned urgently due to a reason such as a decrease in electric power of a battery equipped therein, or an interruption of communication with a wireless operator. Among the current emergency response measures, there is a method of returning at the highest altitude during flight in order to avoid obstacles, a method of landing the unmanned aerial vehicle on the spot, or the like. However, returning at the highest altitude during flight increases the amount of consumption of the battery, and the landing of the unmanned aerial vehicle on the spot has a huge risk since the status of the landing site is sometimes unknown. Therefore, an object of the present disclosure is to improve a technique related to actions during returning and landing of an unmanned aerial vehicle capable of reducing risk.

### Means for Solving the Problem

A disclosure according to a first aspect is a path selection device for controlling flight of an unmanned aerial vehicle, comprising: a landing position information receiving portion that receives a landing position of the unmanned aerial vehicle; a vehicle body position information receiving portion that receives the current position of the unmanned aerial vehicle; a scanned data receiving portion capable of receiving three-dimensional scanned data on a scanned target acquired by scanning by a laser scanner comprised in the unmanned aerial vehicle; a scan map creating portion that creates a three-dimensional map based on the three-dimensional scanned data received by the scanned data receiving portion; a no-fly place extracting portion that extracts a no-fly place forming a flight obstacle in the three-dimensional map; and a path selecting portion that selects, in the three-dimensional map, a flight path of the unmanned aerial vehicle which is from the current position to the landing position of the unmanned aerial vehicle and can bypass the no-fly place.

A disclosure according to a second aspect is characterized in that, in the disclosure according to the first aspect, the scan map creating portion displays, in a stereoscopic manner on the three-dimensional map, a place whose three-dimensional scanned data is not obtained by the laser scanner provided in the unmanned aerial vehicle; the no-fly place extracting portion uses, as the no-fly place, the place displayed on the three-dimensional map in a stereoscopic manner on which three-dimensional scanned data is not obtained by the laser scanner comprised in the unmanned aerial vehicle.

A disclosure according to a third aspect is characterized by, in the disclosure according to the first aspect or the second aspect, comprising a vehicle body manipulation signal generating portion that generates a signal causing the unmanned aerial vehicle to fly on a flight path selected by the path selecting portion. A disclosure according to a fourth aspect is characterized by, in the disclosure according to any one of the first to third aspects, comprising a landable site searching portion that searches, from the three-dimensional map, for a place where the unmanned aerial vehicle can land; wherein the path selecting portion selects a path of the unmanned aerial vehicle, wherein the place which the unmanned aerial vehicle can land at and is searched by the landable site searching portion is used as the landing position.

A disclosure according to a fifth aspect is characterized by, in the disclosure according to any one of the first to fourth aspects, comprising an externally created map receiving portion that receives the three-dimensional map created outside the unmanned aerial vehicle; wherein the path selecting portion selects a path of the unmanned aerial vehicle using the three-dimensional map received by the externally created map receiving portion.

A disclosure according to a sixth aspect is characterized by, in the disclosure according to any one of the first to fifth aspects, comprising at least one of: a flight distance calculating portion capable of calculating a flight distance during the unmanned aerial vehicle is flying on a flight path selected by the path selecting portion, and a battery consumption amount calculating portion capable of calculating a battery consumption amount during the unmanned aerial vehicle is flying on a flight path selected by the path selecting portion; wherein the path selecting portion selects a path of the unmanned aerial vehicle using at least one of the flight distance and the battery consumption amount as a path selection factor.

A disclosure according to a seventh aspect is an unmanned aerial vehicle comprising a path selection device according to any one of the first to sixth aspects. A disclosure according to an eighth aspect is a data processing device comprising a path selection device according to any one of the first to sixth aspects.

A disclosure according to a ninth aspect is a control method for an unmanned aerial vehicle for controlling flight of an unmanned aerial vehicle, comprising: a landing position information receiving step of receiving a landing position of the unmanned aerial vehicle; a vehicle body position information receiving step of receiving the current position of the unmanned aerial vehicle; a scanned data receiving step of receiving three-dimensional scanned data on a scanned target acquired by scanning by a laser scanner comprised in the unmanned aerial vehicle; a scan map creating step of creating a three-dimensional map based on the three-dimensional scanned data received in the scanned data receiving step; a no-fly place extracting step of extracting a no-fly place forming a flight obstacle in the three-dimensional map; and a path selecting step of selecting, in the three-dimensional map, a flight path of the unmanned aerial vehicle which is from the current position to the landing position of the unmanned aerial vehicle and in which the no-fly place can be avoided.

A disclosure according to a tenth aspect is a program for path selection, which is a program for controlling flight of an unmanned aerial vehicle that is read and executed by a computer, causing the computer to function as: a landing position information receiving portion that receives a landing position of the unmanned aerial vehicle; a vehicle body position information receiving portion that receives the current position of the unmanned aerial vehicle; a scanned data receiving portion capable of receiving three-dimensional scanned data on a scanned target acquired by scanning by a laser scanner comprised in the unmanned aerial vehicle; a scan map creating portion that creates a three-dimensional map based on the three-dimensional scanned data received by the scanned data receiving portion; a no-fly place extracting portion that extracts a no-fly place forming a flight obstacle in the three-dimensional map; and a path selecting portion that selects, in the three-dimensional map, a flight path of the unmanned aerial vehicle which is from the current position to the landing position of the unmanned aerial vehicle and in which the no-fly place can be avoided.

### Effects of the Disclosure

According to the present disclosure, when a problem occurs that it is necessary for an unmanned aerial vehicle such as a UAV in flight to return or land, it is possible to select an action with less risk. For example, when there is a sudden decrease in battery during flight of the UAV and the UAV is required to make a certain response, a flight path can be selected on the UAV side where an object forming an obstacle can be avoided and a battery consumption amount can be suppressed as much as possible, so as to return or land the UAV.

### BRIEF DESCRIPTION OF DRAWINGS

FIG. 1 is a conceptual diagram of an embodiment.

FIG. 2 is a block diagram of a UAV.

FIG. 3 is a block diagram of a path selection device comprised in the UAV.

FIG. 4 is a conceptual diagram of a three-dimensional map.

FIG. 5 is a flowchart showing an example of processing.

FIG. 6 is a flowchart showing an example of processing.

FIG. 7 is a block diagram of an external data processing device.

FIG. 8 is a flowchart showing an example of processing.

FIG. 9 is a block diagram of an external data processing device.

### DETAILED DESCRIPTION

### 1. First Embodiment

(Overview)

In general, when an unmanned aerial vehicle such as a UAV is performing an action accompanied by an altitude increase in the air, a large amount of electric power is consumed, and the electric quantity of the equipped battery may be insufficient. Therefore, in the present embodiment, a configuration is shown in which it is possible to select a path enabling a return without performing an altitude increasing action as far as possible.

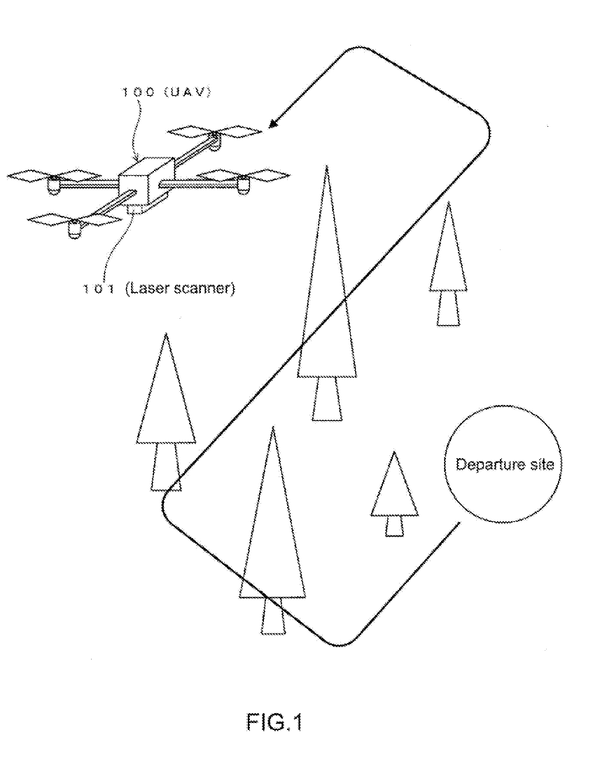

A flying UAV 100 is shown in FIG. 1. The UAV 100 comprises a laser scanner 101, and creates, based on data obtained by laser scanning while flying, a three-dimensional map of places through which it passes as a flight path. The UAV 100 uses the three-dimensional map to select a flight (return) path.

Furthermore, the UAV 100 used in the present disclosure performs autonomous flight in accordance with a predetermined flight route, but flight control may also be performed by wireless manipulation.

(Structure of the UAV)

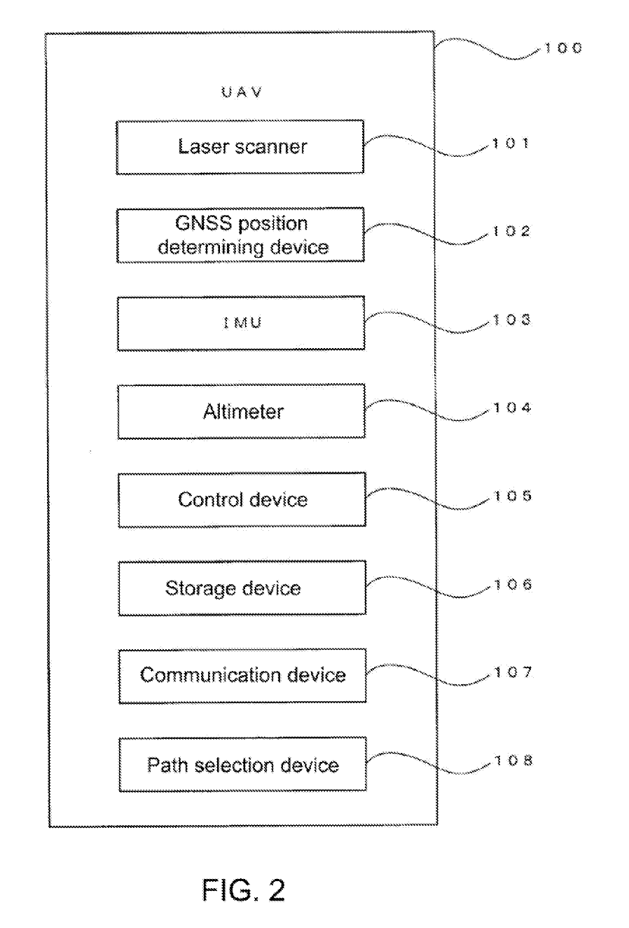

FIG. 2 is a block diagram of the UAV 100. The UAV 100 comprises a laser scanner 101, a GNSS position determining device (GNSS receiver) 102 using GNSS, an IMU (inertial measurement device) 103, an altimeter 104, a control device 105, a storage device 106, a communication device 107, and a path selection device 108.

The laser scanner 101 scans an object to be measured by a laser beam, and detects reflected light of the laser beam so as to obtain an approximate shape of the object to be measured as point cloud data having three-dimensional coordinates. In the utilization of the present disclosure, within a range that can be scanned during flight, an object that can be an obstacle during returning of the UAV 100 is used as a target to be measured. The laser scanner 101 is described in, for example, Japanese Patent Publication No. 2010-151682, Japanese Patent Publication No. 2008-268004, U.S. Pat. Nos. 8,767,190, 7,969,558, etc. In addition, as the laser scanner 101, an apparatus that performs electronic scanning may also be employed (see, for example, US 2015/0293224).

The GNSS position determining device 102 receives a navigation signal from a navigation satellite represented by a GPS satellite, and performs positioning (determination of a position) on this basis. The position (longitude/latitude/altitude) of the GNSS position determining device 102 (the position of an antenna of the GNSS position determining device 102) in a map coordinate system is determined by the GNSS position determining device 102. The map coordinate system is a global coordinate system used when processing map data. Positional data obtained by the GNSS position determining device (for example, a general-purpose GPS receiver) is usually obtained as data in the map coordinate system.

The positioning to be performed by the GNSS position determining device 102 includes a single point positioning with low installation cost but low precision, or a relative positioning with high installation cost but high precision. Either of them can be used in the present disclosure. However, in order to allow the unmanned aerial vehicle such as the UAV to fly autonomously, it is necessary to acquire position information on the vehicle body as high-precision information, therefore positioning with high measurement precision such as relative positioning is desirable. As a technique of high-precision relative positioning, for example, a way of position measurement with high precision (with an error of several centimeters or less) using RTK (Real Time Kinematic) positioning may be exemplified. The RTK positioning is described on, for example, the homepage of the Geospatial Information Authority of Japan (http://terras.gsi.go.jp/geo_info/GNSS_iroiro.html).

In the RTK positioning, a fixed base station (GNSS, or TS with a GNSS device, or the like) is prepared at the site where the UAV 100 is flying, and the fixed base station and the UAV 100 perform positioning while communicating with the navigation satellite. By this positioning, the position information on the UAV 100 can be obtained with high precision.

In addition, the GNSS position determining device 102 has the function of a clock, and the position information on the UAV 100 or the laser scanned data is stored in a flight log together with information on the corresponding time.

The IMU 103 measures an acceleration applied to the UAV 100 in flight. An output from the IMU 103 is used for control of a posture of the UAV 100 in flight. In addition, information about the posture of the UAV 100 in flight is obtained from the output from the IMU 103. The altimeter 104 measures an air pressure and measures the altitude of the UAV 100.

The control device 105 performs various controls related to the UAV 100, in addition to selection of a flight path described later. The various controls related to the UAV 100 include flight control, control related to irradiation (scanning) by the laser scanner 101, control related to management of data stored in the storage device 106, and control related to an action of the communication device 107.

The storage device 106 stores a flight plan for flying over a predetermined flight path, and a flight log. The flight log is data that stores a position (longitude, latitude, altitude) in flight and data on the time at which it is measured. The measurement of the position in flight is performed at a specific time interval of 0.5 seconds or 1 second) (of course, there may be a case of irregular timing), and the positional data measured in real time is stored in the flight log in association with the measurement time. In addition, the time at which the laser scanner 101 performs irradiation (scanning) and the image data, data about the posture of the UAV 100 measured by the IMU 103, and altitude data measured by the altimeter 104 are also stored in the storage device 106 in a state of being associated with the flight log.

The communication device 107 has a wireless communication function. The communication device 107 performs, by means of the wireless communication function, transmission and reception of an operation signal between the UAV 100 and an operating apparatus (a controller operated by an operator operating the UAV 100 on the ground), communication for location positioning performed between the UAV 100 and the fixed base station or the navigation satellite, and transmission and reception of scanned data scanned by the UAV 100 in flight, a three-dimensional map created from the scanned data, or positioning data to/from other apparatuses.

The communication device 107 has a wired communication function in addition to the wireless communication function. The communication device 107 uses the wired communication function to perform communication between the UAV 100 in a non-flight state (landed state) and other apparatuses. For example, reception of a signal related to a flight operation (reception of a control signal from an operation controller), reception of data on a flight plan, transmission of log data to other apparatuses, and the like are performed by the communication device 107. Furthermore, the communication device 107 may also have an optical communication function. The above description of the communication device 107 is also applicable to a communication portion 304 and a communication device 401 described later.

The path selection device 108 creates a three-dimensional map from the scanned data obtained by the laser scanner 101. Then, an object forming an obstacle to the flight of the UAV 100 is extracted using the three-dimensional map, and an optimum path is selected by avoiding a place where the extracted obstacle is present or a place where laser scanning is not performed and where the status is unknown.

(Structure of the Path Selection Device)

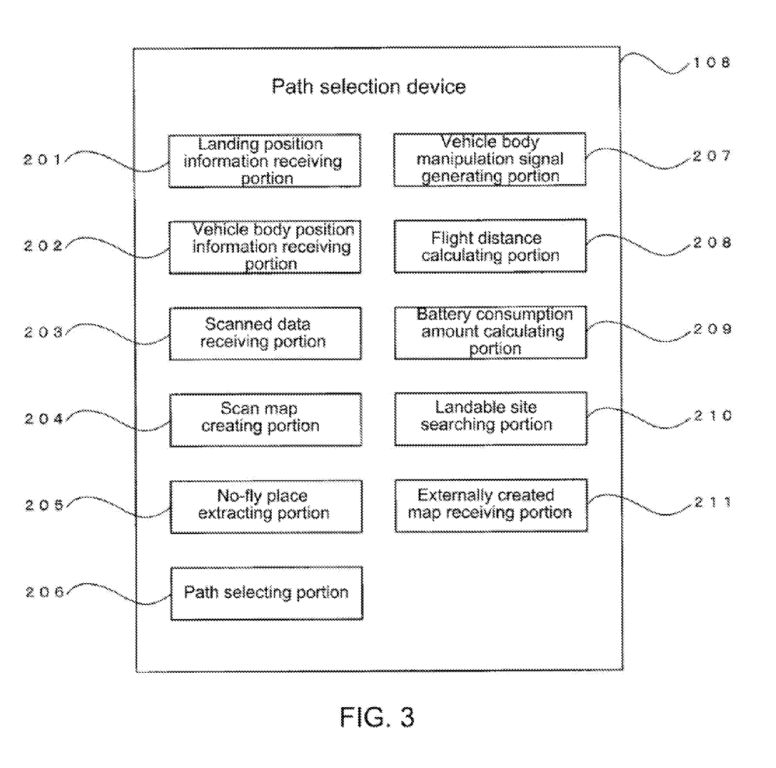

FIG. 3 is a block diagram of the path selection device 108. The path selection device 108 of the present embodiment comprises a landing position information receiving portion 201, a vehicle body position information receiving portion 202, a scanned data receiving portion 203, a scan map creating portion 204, a no-fly place extracting portion 205, a path selecting portion 206, and a vehicle body manipulation signal generating portion 207.

Each of the functional portions of the control device 105 shown in FIG. 3 is constructed by, for example, an electronic circuit such as a CPU (Central Processing Unit), an ASIC (Application Specific Integrated Circuit), a PLD (Programmable Logic Device) represented by an FPGA (Field Programmable Gate Array), or the like. In addition, it is also possible to construct a part of the functions by dedicated hardware, and construct the other part thereof by a general-purpose microcomputer.

It is determined, in consideration of the required calculation speed, cost, power consumption, and the like, whether each of the functional portions is constructed by dedicated hardware or is constructed by software by executing a program in the CPU. Furthermore, the constructions of the functional portion by dedicated hardware and by software are equivalent from the viewpoint of implementing the determined function.

The landing position information receiving portion 201 receives position information on a site where the UAV 100 is to be returned or landed. Furthermore, the number of the received pieces of position information is not limited to one, or may also be more than one.

The vehicle body position information receiving portion 202 receives position information on the UAV 100 determined by the GNSS position determining device 102. The scanned data receiving portion 203 acquires laser scanned data scanned by the laser scanner 101. The above structures of the vehicle body position information receiving portion 202 and the scanned data receiving portion 203 are also applicable to a vehicle body position information receiving portion 301 and a scanned data receiving portion 302 described later.

The scan map creating portion 204 creates a three-dimensional map from the laser scanned data received by the scanned data receiving portion 203. Here, since the laser scanned data acquired by the laser scanner 101 is obtained by a coordinate system fixed to the flying UAV 100, scanning points are subjected to coordinate transformation into a map coordinate system based on the position and posture of the UAV 100 during scanning. The coordinate transformation is performed by rotation and translation. Here, the rotation is performed by calculating a rotation matrix based on the data on the posture obtained from the IMU 103, and the translation is performed by calculating a translation vector according to the data on the position of the UAV 100 obtained from the GNSS position determining device 102. A technique for coordinate transformation of the laser scanned data obtained from the flying UAV into a map coordinate system (ground coordinate system) is described in, for example, Japanese Patent Application No. 2017-178831.

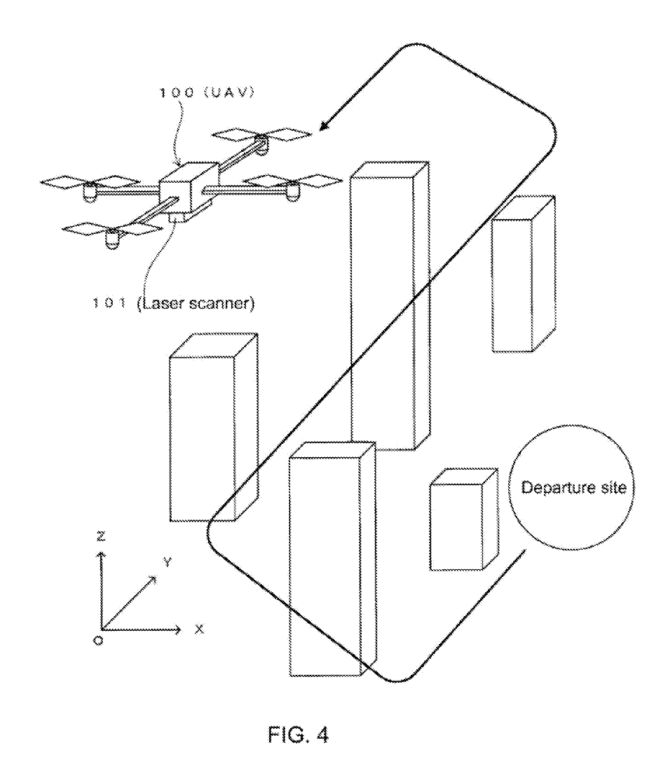

The created three-dimensional map may also be an outline map, and a three-dimensional map created from the terrain of FIG. 1 is, for example, as shown in FIG. 4. The three-dimensional map presents a three-dimensional space expressed by (x, y, z) components, and the maximum width, maximum depth, and altitude of a measured object are expressed by the (x, y, z) components, respectively. Therefore, the measured object is approximated to a rectangular parallelepiped in the three-dimensional space. In addition, a place outside the flight path of the UAV 100 where laser scanning cannot be performed and where the status is unknown is also approximated to a rectangular parallelepiped. The above description is also applicable to a scan map creating portion 303 described later.

The no-fly place extracting portion 205 extracts an object that forms an obstacle to the flight of the UAV 100 or a place where the UAV 100 is not allowed to fly due to its unknown status, as a no-fly place, in the three-dimensional map created by the scan map creating portion 204. For example, if the no-fly place is to be extracted for a path of a straight flight from the position of the UAV 100 at any time point to a return site, the positions of the UAV 100 and the return site on the three-dimensional map are determined, and a rectangular parallelepiped overlapping a straight line connecting the two points forms an obstacle.

The path selecting portion 206 selects an optimum path from among one or more paths enabling flight while avoiding an obstacle. The one or more paths enabling flight while avoiding an obstacle may be set in advance as a candidate route, or a flyable path may also be searched by the path selecting portion 206 according to the three-dimensional map created by the scan map creating portion 204 and the obstacle extracted by the obstacle extracting portion 205. When it is necessary to make a judgment when multiple flyable paths are searched, an optimum path is selected in consideration of the flight distance, the amount of electric power consumed, etc., in regard to paths where the extracted obstacle can be avoided.

For the selection of the path, for example, the following methods may be exemplified. First, a three-dimensional map is set and created by the scan map creating portion 204 as (x, y, z)=(100, 100, 100) composed of 100 unit spaces ((x, y, z)=(1, 1, 1)). Moreover, respective value of (x, y, z) of the width, depth and altitude of an obstacle or a place in an unknown status, i.e., a no-fly place, is expressed by integers, and if its position is also expressed by (x, y, z) with 1≤x, y, z≤100, it is known which unit space on the three-dimensional map has a no-fly place.

Similarly, if the position of the UAV 100 and the position of the return site are also expressed by (x, y, z) with 1≤x, y, z≤100, the position of the UAV 100 and the position of the return site on the three-dimensional map can also be determined. The position of the UAV 100 and the position of the return site determined on the three-dimensional map are corresponding to any one of the 100 unit spaces.

Therefore, a unit space corresponding to the position of the UAV 100 is regarded as a starting site, a unit space corresponding to the position of the return site is regarded as a goal site, a unit space with an obstacle and a unit space without scanned data and in an unknown status are regarded as no-fly places, and a path enabling a return while avoiding (bypassing) an obstacle is obtained by searching for paths where only the unit spaces that are not the no-fly places are traversed from the starting site to the goal site. Further, in order to select the shortest path, a path having the smallest number of unit spaces to be traversed may be selected from the searched paths.

Furthermore, the scale of one side of the unit space may be variable. For example, if a flight is within 100 m, the unit space is set to 1 m×1 m×1 m, and when it exceeds 100 m, the unit space is set to 2 m×2 m×2 m, and thereafter the scale of one side of the unit space is also changed depending on the flight distance so as to cope with a wide variety of flight distances. However, there is such a problem that the unit space with an obstacle becomes larger as the scale is larger. Therefore, in the case of a long flight distance, it is possible to cope with this situation without excessively increasing the scale, by increasing the number of unit spaces constituting the three-dimensional map in advance.

The vehicle body manipulation signal generating portion 207 generates a signal for causing the UAV 100 to fly on the path selected by the path selecting portion 206. Therefore, the generated signal is transmitted to the control device 105 of the UAV 100.

(An Example of Processing)

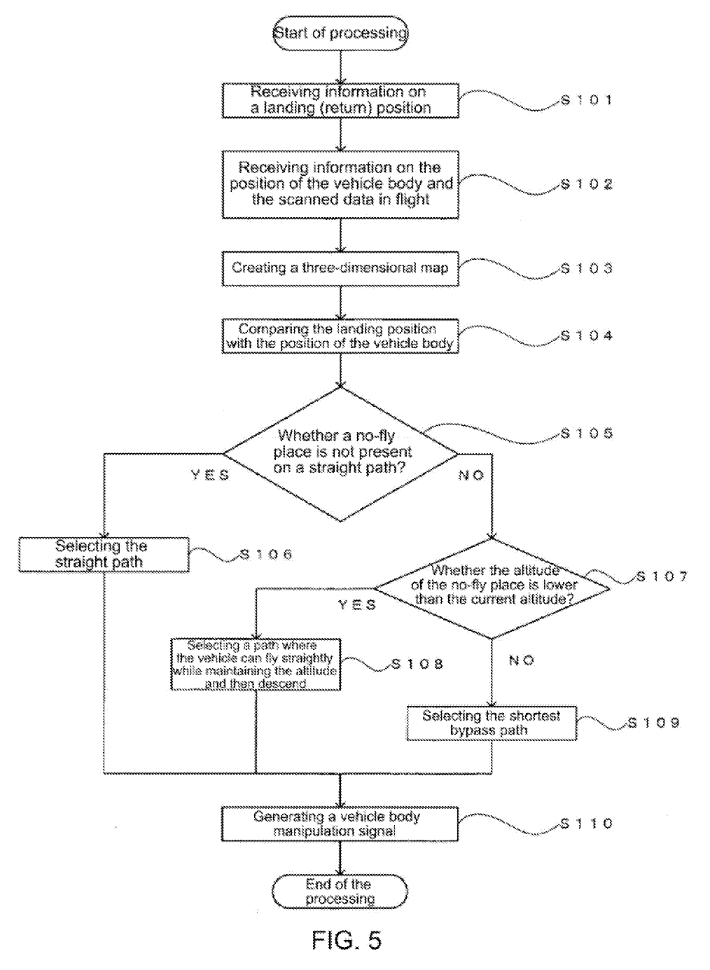

FIG. 5 shows an example of the processing of the present embodiment. First, the UAV 100 receives position information on the return site or landing site. The position information may be received at timing either before start of flight of the UAV 100 or during the flight, but needs to be received before step S104 described later (step S101).

The UAV 100 intermittently scans by the laser scanner 101 while grasping its own position after the start of the flight. Thus, the position information on the UAV 100 and the scanned data are obtained together (step S102). Next, a three-dimensional map is created based on the data obtained in step S102 (step S103).

Then, when there is an opportunity to return the UAV 100, the current position of the UAV 100 and the position of the return site on the three-dimensional map are compared (step S104). Here, as an opportunity to return the UAV 100, an instruction from an operator, a decrease in battery quantity, a device failure, and the like may be exemplified.

Next, it is judged whether a no-fly place is extracted on a straight line connecting the current position of the UAV 100 and the return position, and it is confirmed whether a no-fly place is not present (step S105). In step S105, if a no-fly place is not present, a straight path in which the current position of the UAV 100 and the return position are straightly connected is selected as a return path (step S106). In step S105, if a no-fly place is present, it is judged whether the altitude of the no-fly place is lower than the current position of the UAV 100. Here, if multiple no-fly places are present, a no-fly place having the highest altitude becomes a target to be compared (step S107).

If the no-fly place has a low altitude, a path is selected in which the UAV can fly to overhead the return position while maintaining the altitude and descend to the return site (step S108). If the no-fly place has a high altitude, a path is selected in which the UAV can bypass to avoid an obstacle and fly towards the return site in the shortest route (step S109). Finally, a signal causing the UAV 100 to fly on the determined path is generated, thereby the processing is finished (step S110).

In the present embodiment, it is assumed that three flight paths (actions) are set in advance in the path selecting portion 206, which are a straight path in which the current position of the UAV 100 and the return position are straightly connected, a path in which the UAV can fly to overhead the return position while maintaining the altitude and descend to the return site, and a path in which the UAV can bypass to avoid a no-fly place and fly towards the return site in the shortest route. However, the flight path (action) set in the path selecting portion 206 may be, for example, arbitrarily set by the operator of the UAV 100. If the flight path (action) is to be arbitrarily set, the setting is performed before the process of step S105 is started for handling.

(Variant Example)

Due to the fact that an amount of consumption of electric power of the battery corresponding to each flight action of the UAV 100 is known or similar facts, if it is possible to estimate a battery consumption amount during a flight from the current position of the UAV 100 to the return site, it is also possible to extract a no-fly place, search for paths where the no-fly place can be avoided, calculate the battery consumption amounts for the obtained paths, and select a path with the lowest battery consumption amount after steps S101 to 104 are performed.

In this case, the structure of the path selection device 108 may comprise a flight distance calculating portion 208 and a battery consumption amount calculating portion 209, in addition to the landing position information receiving portion 201, the vehicle body position information receiving portion 202, the scanned data receiving portion 203, the scan map creating portion 204, the no-fly place extracting portion 205, the path selecting portion 206, and the vehicle body manipulation signal generating portion 207.

The flight distance calculating portion 208 calculates a flight distance for a path from the current position of the UAV 100 to the return site that is searched by the path selecting portion 206. For a method of calculating the flight distance, for example, given a three-dimensional map constructed as a set of unit spaces, the flight distance can be calculated according to the scale of the unit space.

The battery consumption amount calculating portion 209 calculates an electric power consumption during the unmanned aerial vehicle is flying on a predetermined path. For example, if an amount of consumption of electric power of the battery corresponding to each flight action of the UAV 100 is obtained as data, the electric power consumption can be calculated according to the flight path searched by the path selecting portion 206 and the flight distance calculated by the flight distance calculating portion 208.

### 2. Second Embodiment

(Overview)

When an opportunity to return the unmanned aerial vehicle such as the UAV occurs, a takeoff site is often used as the return site. However, it may be assumed that the remaining amount of the equipped battery is insufficient for return to the takeoff site. Therefore, a mode is shown in which a path is selected using a landable site other than the takeoff site as a final landing site.

(Structure)

The structure of the UAV 100 is as shown in FIG. 2, and is not different from the first embodiment. However, the path selection device 108 comprises a landing position information receiving portion 201, a vehicle body position information receiving portion 202, a scanned data receiving portion 203, a scan map creating portion 204, a no-fly place extracting portion 205, a path selecting portion 206, a vehicle body manipulation signal generating portion 207, a flight distance calculating portion 208, a battery consumption amount calculating portion 209, and a landable site searching portion 210 in FIG. 3.

The landable site searching portion 210 searches for a site, where the UAV 100 can land, from a three-dimensional map created by the scan map creating portion 204. As a search for a landable site, a site with z=0 is selected as a landable site, which is a flat land, on a three-dimensional space expressed by (x, y, z) components, which is a three-dimensional map.

Here, there may be a case where the site with z=0 is not a land but a water surface such as a river. Therefore, when sites with z=0 are slenderly continuous, it is judged that these places are rivers, and this situation is handled by excluding them from the landable sites. That is, a feature of a terrain capable of generating a risk of being flooded or the like during landing is defined in advance, and a place having the defined feature is excluded during the searching of the landable site.

A process is preferable in which a place with z=0 and with a width of a threshold or more (for example, 5 m×5 m or more) is selected as the landable site. In addition, in this case, a process is also effective in which a place where z is not equal to 0 but z is equal to a constant value (or a place where z can be regarded as a constant value) is selected as a flat land.

(An Example of Processing)

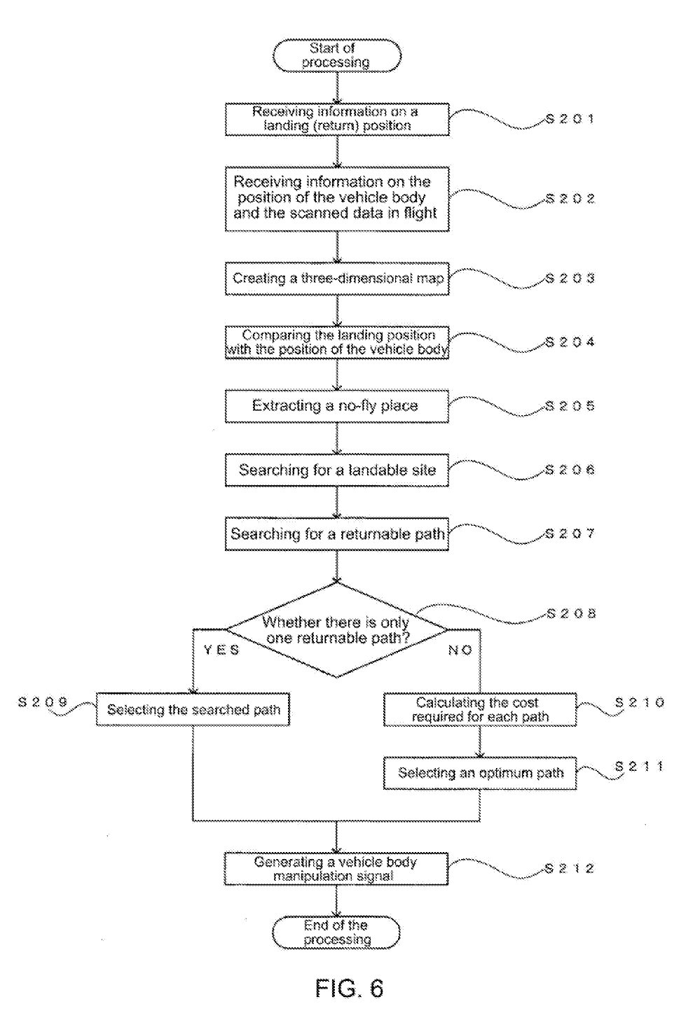

FIG. 6 shows an example of the processing of the present embodiment. First, the UAV 100 receives position information on a landing site. Here, the received position information on the landing site refers to position information on a landable site if there is the landable site at a takeoff site and within the range that can be visually observed by an operator of the UAV 100. Furthermore, these pieces of position information are received by the landing position information receiving portion 201 (step S201).

Then, the unmanned aerial vehicle flies while obtaining position information on the aerial vehicle itself and scanned data (step S202). A three-dimensional map is created according to the obtained position information on the aerial vehicle itself and scanned data (step S203). The current position of the UAV 100 on the created three-dimensional map is compared with the position(s) of one or more landing sites received in step S201 (step S204).

Next, after a no-fly place is extracted (step S205), it is searched on the three-dimensional map whether there is a landable site in addition to the landing site received in step S201, and if there is a landable site, the site is also added as a landing site (step S206). Next, a path where the current position of the UAV 100 and the position(s) of one or more landing sites are connected and where the no-fly place can be avoided is searched on the three-dimensional map (step S207).

Next, if one path is searched in step S207 (step S208), this path is selected (step S209). If the number of the paths searched in step S207 is not one but more than one (step S208), the assumed cost such as the flight distance or battery consumption amount for each path is calculated (step S210). Then, an optimum path is selected in consideration of the assumed cost of each path (step S211). Finally, a signal causing the UAV 100 to fly on the selected path is generated (step S212), and the processing is finished.

(Variant Example)

The extraction/determination of the path may also be performed by using the landable site searched by the landable site searching portion 210 as the final landing site, without receiving the landing site by the landing position information receiving portion 201. However, in the case where the landing site searching portion 210 does not find a landable site, this situation is handled by, for example, taking a risk to land on the spot.

### 3. Third Embodiment

(Overview)

It is also possible to adopt a configuration in which the path selection is carried out by performing laser scanning on the UAV side, creating a three-dimensional map on the external data processing device side, and using the three-dimensional map on the UAV side. At this time, the scanned data obtained on the UAV side is transmitted to the external data processing device side, and the external data processing device side creates a three-dimensional map according to the received scanned data. Then, the three-dimensional map created by the external data processing device side is transmitted to the UAV side.

In the present embodiment, a three-dimensional map is created by both the UAV 100 and the external data processing device 300 on the scanned data obtained by the UAV 100. The advantage of creating a three-dimensional map by both the UAV 100 and the external data processing device 300 is that the UAV 100 can return using a three-dimensional map created by the UAV 100 even in the case where the UAV 100 fail to receive data of the three-dimensional map created by the external data processing device 300 due to communication disconnection or the like, and that it is possible to cope with a case where a device capable of processing a large amount of data in real time has a weight that cannot be loaded onto the flying object, i.e., the UAV 100.

Furthermore, since the device loaded on the UAV 100 is provided in order to prevent an accidental situation such as a situation in which data of the three-dimensional map created by the external data processing device 300 cannot be obtained, it does not need to have high processing capability.

(Structure)

The structure of the UAV 100 is as shown in FIG. 2, and is not different from the first embodiment and the second embodiment. However, the path selection device 108 comprises a landing position information receiving portion 201, a vehicle body position information receiving portion 202, a scanned data receiving portion 203, a scan map creating portion 204, a no-fly place extracting portion 205, a path selecting portion 206, a vehicle body manipulation signal generating portion 207, a flight distance calculating portion 208, a battery consumption amount calculating portion 209, and an externally created map receiving portion 211 in FIG. 3.

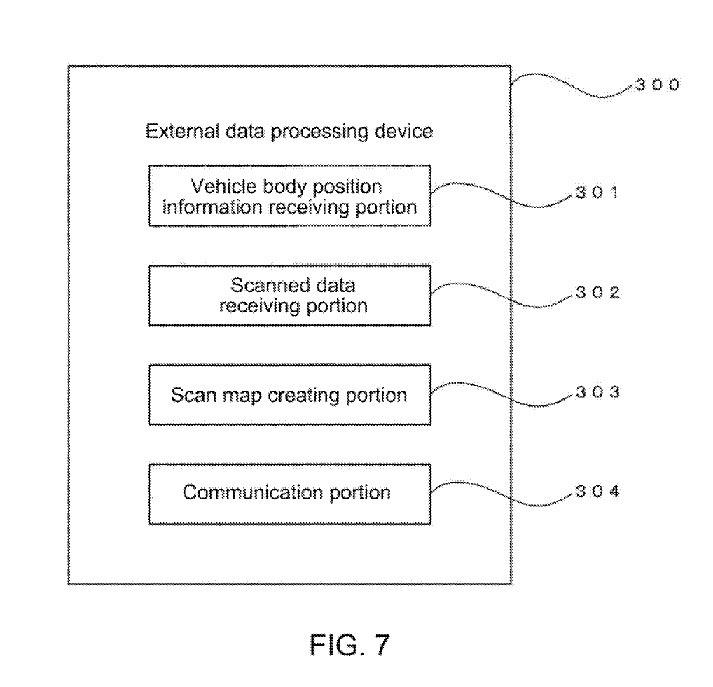

The structure of the external data processing device 300, as shown in FIG. 7, comprises a vehicle body position information receiving portion 301, a scanned data receiving portion 302, a scan map creating portion 303, and a communication portion 304. Examples of the external data processing device may include a TS (total station) having the structure shown in FIG. 7, etc.

(An Example of Processing)

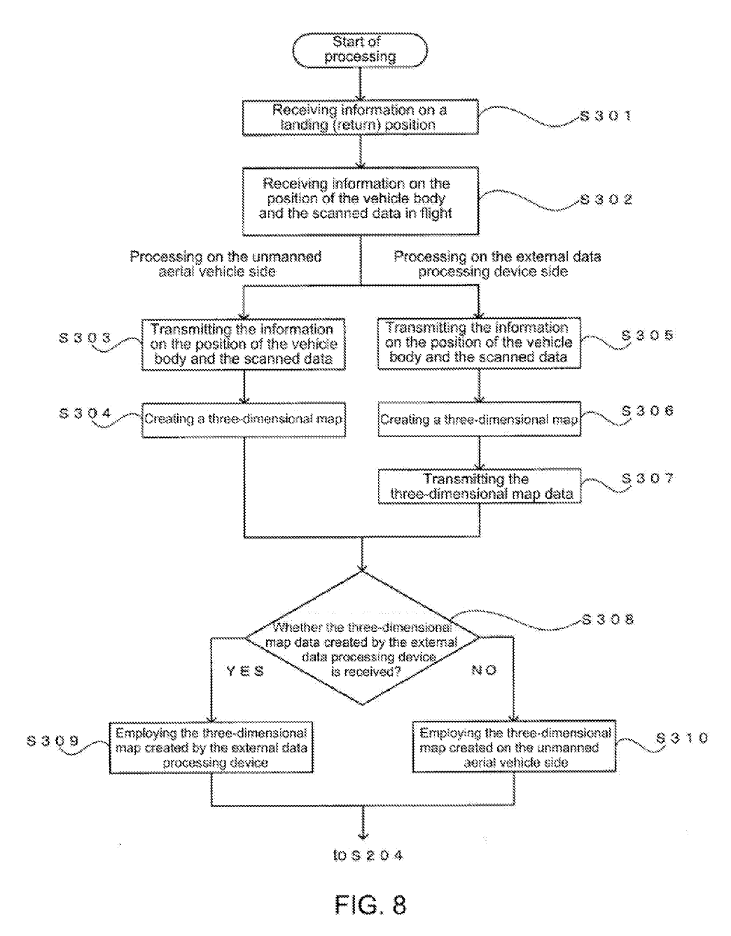

FIG. 8 shows an example of the processing of the present embodiment. First, the UAV 100 receives position information on a landing site (step S301). Then, the unmanned aerial vehicle flies while receiving position information on the aerial vehicle itself and scanned data (step S302). The obtained position information on the aerial vehicle itself and scanned data are transmitted from the UAV 100 to the external data processing device (step S303), and are used for creating a three-dimensional map on the UAV 100 side (step S304).

If the external data processing device receives the position information on the UAV 100 and the scanned data from the UAV 100 (step S305), a three-dimensional map is also created on the external data processing device side (step S306). The data of the three-dimensional map created on the external data processing device side is transmitted to the UAV 100 side at any time (step S307). Since the UAV 100 is in flight and the position of the vehicle body is constantly changing, it is desirable that an interval of transmission of the three-dimensional map data be as short as possible (several seconds or less).

Then, if the UAV 100 can receive the data of the three-dimensional map created on the external data processing device side, these data are preferentially employed (steps S308, S309, and S310). Thereafter, the same processing as the subsequent steps following step S204 in FIG. 6 is executed using the employed three-dimensional map.

In addition, if the external data processing device 300 scans around the UAV 100 like a TS (Total Station) and obtains the scanned data, the scanned data can be used when the three-dimensional map is being created in step S306.

When a three-dimensional map is created on the external data processing device side and the data is transmitted to the UAV 100 side as in the present embodiment, it is necessary to perform data communication in real time. Here, if the definition of unit spaces constituting a three-dimensional map is set as a definition common to the UAV 100 and the external data processing device by using the foregoing method of constructing a three-dimensional map by unit spaces, then the search of a return path and the selection of an optimum path can be performed on the UAV 100 side by transmitting information indicating whether the respective unit spaces constituting the three-dimensional map are no-fly spaces after creating the three-dimensional map by the external data processing device. That is, the UAV 100 can perform the search and selection of the return path by transmitting, from the external data processing device, a binary signal identical to the number of the unit spaces constituting the three-dimensional map.

### 4. Fourth Embodiment

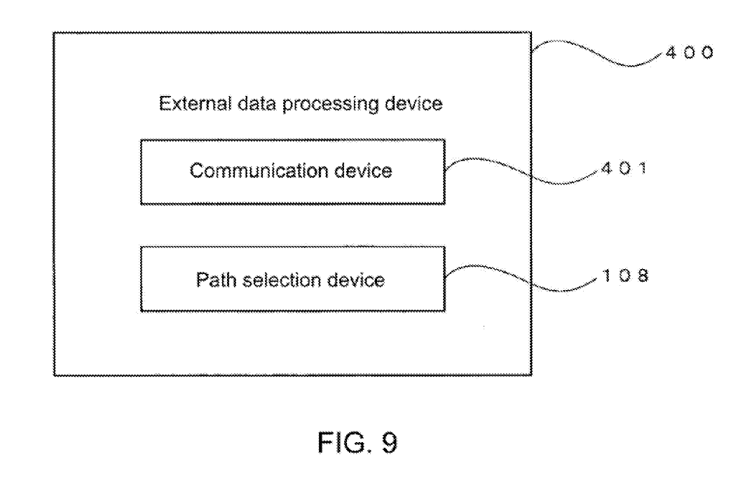

The path selection device 108 is not limited to the configuration provided in the UAV 100. For example, as shown in FIG. 9, an external data processing device 400 comprising a communication device 401 and a path selection device 108 can receive position information on the UAV 100 and scanned data obtained by the UAV 100 through the communication device 401 to create a three-dimensional map and determine a return path. Then, the UAV 100 is returned by transmitting to the UAV 100 a vehicle body manipulation signal that causes it to fly on the determined return path.

### INDUSTRIAL APPLICABILITY

The present disclosure can be used to determine a return path of or a path to a landing site of an unmanned aerial vehicle.

What is claimed is:

1. A path selection device for controlling flight of an unmanned aerial vehicle, comprising:
a landing position information receiving portion that receives a landing position of the unmanned aerial vehicle;
a vehicle body position information receiving portion that receives a current position of the unmanned aerial vehicle;
a scanned data receiving portion capable of receiving three-dimensional scanned data on a scanned target acquired by scanning by a laser scanner comprised in the unmanned aerial vehicle;
a scan map creating portion that creates a three-dimensional map based on the three-dimensional scanned data received by the scanned data receiving portion;
a no-fly place extracting portion that extracts a no-fly place forming a flight obstacle in the three-dimensional map; and
a path selecting portion that selects, in the three-dimensional map, a flight path of the unmanned aerial vehicle, which is from the current position to the landing position of the unmanned aerial vehicle and can bypass the no-fly place.

2. The path selection device according to claim 1,
wherein the scan map creating portion displays, in a stereoscopic manner on the three-dimensional map, a place whose the three-dimensional scanned data is not obtained by the laser scanner provided in the unmanned aerial vehicle; and
the no-fly place extracting portion uses, as the no-fly place, the place displayed on the three-dimensional map in the stereoscopic manner whose the three-dimensional scanned data is not obtained by the laser scanner provided in the unmanned aerial vehicle.

3. The path selection device according to claim 1,
comprising a vehicle body manipulation signal generating portion that generates a signal causing the unmanned aerial vehicle to fly on the flight path selected by the path selecting portion.

4. The path selection device according to claim 1,
comprising a landable site searching portion that searches, from the three-dimensional map, for a place where the unmanned aerial vehicle can land,
wherein the path selecting portion selects a path of the unmanned aerial vehicle, wherein the place which the unmanned aerial vehicle can land at and is searched by the landable site searching portion is used as the landing position.

5. The path selection device according to claim 1,
comprising an externally created map receiving portion that receives the three-dimensional map created outside the unmanned aerial vehicle,
wherein the path selecting portion selects a path of the unmanned aerial vehicle using the three-dimensional map received by the externally created map receiving portion.

6. The path selection device according to claim 1,
comprising at least one of:
a flight distance calculating portion capable of calculating a flight distance during the unmanned aerial vehicle is flying on the flight path selected by the path selecting portion, and
a battery consumption amount calculating portion capable of calculating a battery consumption amount during the unmanned aerial vehicle is flying on the flight path selected by the path selecting portion,
wherein the path selecting portion selects a path of the unmanned aerial vehicle using at least one of the flight distance and the battery consumption amount as a path selection factor.

7. A control method of an unmanned aerial vehicle for controlling flight of the unmanned aerial vehicle, comprising:
a landing position information receiving step in which a landing position of the unmanned aerial vehicle is received;
a vehicle body position information receiving step in which a current position of the unmanned aerial vehicle is received;
a scanned data receiving step in which three-dimensional scanned data on a scanned target acquired by scanning by a laser scanner provided in the unmanned aerial vehicle is received;
a scan map creating step in which a three-dimensional map based on the three-dimensional scanned data received in the scanned data receiving step is created;
a no-fly place extracting step in which a no-fly place forming a flight obstacle in the three-dimensional map is extracted; and
a path selecting step in which a flight path of the unmanned aerial vehicle is selected from the three-dimensional map, wherein the flight path is from the current position to the landing position of the unmanned aerial vehicle and capable of bypassing the no-fly place.

8. A program for path selection, which is a program for controlling flight of an unmanned aerial vehicle that is read and executed by a computer,
causing the computer to function as:
a landing position information receiving portion that receives a landing position of the unmanned aerial vehicle;
a vehicle body position information receiving portion that receives a current position of the unmanned aerial vehicle;
a scanned data receiving portion capable of receiving three-dimensional scanned data on a scanned target acquired by scanning by a laser scanner comprised in the unmanned aerial vehicle;
a scan map creating portion that creates a three-dimensional map based on the three-dimensional scanned data received by the scanned data receiving portion;
a no-fly place extracting portion that extracts a no-fly place forming a flight obstacle in the three-dimensional map; and
a path selecting portion that selects, in the three-dimensional map, a flight path of the unmanned aerial vehicle which is from the current position to the landing position of the unmanned aerial vehicle and in which the no-fly place can be avoided.

9. The path selection device according to claim 2,
comprising an externally created map receiving portion that receives the three-dimensional map created outside the unmanned aerial vehicle,
wherein the path selecting portion selects a path of the unmanned aerial vehicle using the three-dimensional map received by the externally created map receiving portion.

10. The path selection device according to claim 3,
comprising an externally created map receiving portion that receives the three-dimensional map created outside the unmanned aerial vehicle,
wherein the path selecting portion selects a path of the unmanned aerial vehicle using the three-dimensional map received by the externally created map receiving portion.

11. The path selection device according to claim 4,
comprising an externally created map receiving portion that receives the three-dimensional map created outside the unmanned aerial vehicle,
wherein the path selecting portion selects a path of the unmanned aerial vehicle using the three-dimensional map received by the externally created map receiving portion.
